(19) United States
(12) Patent Application Publication
(10) Pub. No.: US 2008/0033612 A1
(43) Pub. Date: Feb. 7, 2008

(54) Device and Method for Stabilizing a Motor Vehicle

(75) Inventor: Markus Raab, Kirchhardt (DE)

Correspondence Address: FITCH, EVEN, TABIN & FLANNERY, P. O. BOX 18415, WASHINGTON, DC, 20036, US

(73) Assignee: DaimerlerChrysler AG, Stuttgart (DE)

(21) Appl. No.: 11/630,852

(22) PCT Filed: Jun. 16, 2005
(86) PCT No.: PCT/EP05/06451

§ 371 Date: Dec. 22, 2006

(30) Foreign Application Priority Data
Jun. 25, 2004 (DE) 10 2004 030 708.3
Oct. 6, 2004 (DE) 10 2004 048 531.3

(51) Int. Cl. B60G 17/016

(52) U.S. Cl. 701/38

(57) ABSTRACT

The invention relates to a device and a method for stabilizing a vehicle, having a detection device (10) which is provided for determining an actual value of a lateral dynamics variable which describes the lateral dynamics of the vehicle, and having an evaluation unit (11) which determines a setpoint value for the lateral dynamics variable and limits said setpoint value to a limit value which is determined as a function of a prescribed stability condition if it is found that the magnitude of the setpoint value of the lateral dynamics variable exceeds the magnitude of the determined limit value, with the evaluation unit (11) actuating vehicle assemblies (12), which are provided for influencing the longitudinal and/or lateral dynamics of the vehicle, as a function of a comparison of the determined actual value and the determined and possibly limited setpoint value of the lateral dynamics variable in such a way that the driving stability of the vehicle is increased. In this case, the lateral dynamics variable comprises a tilting angle variable which describes a tilting angle of the vehicle, and/or a slip angle variable which describes a slip angle which occurs on a vehicle wheel.

The invention relates to a device and a method for stabilizing a vehicle, having a detection device which is provided for determining an actual value of a lateral dynamics variable which describes the lateral dynamics of the vehicle, and having an evaluation unit which determines a setpoint value for the lateral dynamics variable and limits said setpoint value to a limit value which is determined as a function of a prescribed stability condition if it is found that the magnitude of the setpoint value of the lateral dynamics variable exceeds the magnitude of the determined limit value, with the evaluation unit actuating vehicle assemblies, which are provided for influencing the longitudinal and/or lateral dynamics of the vehicle, as a function of a comparison of the determined actual value and the determined and possibly limited setpoint value of the lateral dynamics variable in such a way that the driving stability of the vehicle is increased.

Such a stabilizing system for a vehicle is disclosed in document DE 198 30 189 A1. The vehicle has a device for controlling the yaw moment, which device adjusts the yaw rate of the vehicle to a setpoint value, which is dependent on driver prespecifications, in a known manner by acting on wheel-braking devices of the vehicle on selected wheels, with the setpoint value being limited to a physically expedient value in order to prevent the vehicle from overturning.

Since there is only an indirect physical relationship between the yaw rate which is used for yaw moment control and the occurrence of a tendency of the vehicle to tilt or skid, inaccuracies necessarily occur when the actual stability state of the vehicle is assessed.

Under unfavorable conditions, this may lead to the wheel-braking devices of the vehicle being acted on on selected wheels in a manner which is not appropriate for the actual stability state.

The object of the present invention is therefore to develop a device and a method of the type mentioned in the introduction in such a way that it is ensured that measures which stabilize the vehicle are carried out in a manner which is appropriate for the actual stability state of the vehicle.

This object is achieved by means of a device and a method according to the features of patent claim 1 and, respectively, patent claim 12.

In addition to a detection device which is provided for determining an actual value of a lateral dynamics variable which describes the lateral dynamics of the vehicle, the device for stabilizing a vehicle comprises an evaluation unit which determines a setpoint value for the lateral dynamics variable and limits said setpoint value to a limit value which is determined as a function of a prescribed stability condition if it is found that the magnitude of the setpoint value of the lateral dynamics variable exceeds the magnitude of the determined limit value, with the evaluation unit actuating vehicle assemblies, which are provided for influencing the longitudinal and/or lateral dynamics of the vehicle, as a function of a comparison of the determined actual value and the determined and possibly limited setpoint value of the lateral dynamics variable in such a way that the driving stability of the vehicle is increased. According to the invention, the lateral dynamics variable comprises a tilting angle variable which describes a tilting angle of the vehicle, and/or a slip angle variable which describes a slip angle which occurs on a vehicle wheel. In this case, the slip angle specifies the angle deviation which occurs between the actual rolling direction of the vehicle wheel and the plane of the rim of said vehicle wheel on account of lateral forces of the wheel.

Inaccuracies when assessing the stability state of the vehicle can largely be avoided since the tilting angle and/or the slip angle are physically directly related to the occurrence of a tendency of the vehicle to tilt and/or skid, so that it is possible to ensure that the measures which stabilize the vehicle are carried out in a manner which is appropriate for the actual stability state of the vehicle.

Advantageous embodiments of the device according to the invention can be found in the subclaims.

The tilting angle variable advantageously describes the tilting angle itself and/or the behavior of the tilting angle over time, so that it is possible to reliably identify a tendency of the vehicle to tilt by evaluating the tilting angle variable. The behavior of the tilting angle over time is given, for example, by differentiating the tilting angle with respect to time. The tilting angle particularly expresses a rotation of the vehicle about an axis of rotation which is oriented in the longitudinal direction of the vehicle, it also being possible for the tilting angle to be a rotation of the vehicle about an axis of rotation which is oriented in the lateral direction of the vehicle or a combination of the two rotations described above.

It is also advantageous for the slip angle variable to describe the slip angle which occurs on a front-wheel axle of the vehicle and/or the slip angle which occurs on a rear-wheel axle of the vehicle. Since the slip angle which occurs on the front-wheel axle and/or the slip angle which occurs on the rear-wheel axle are physically directly related to the occurrence of a tendency of the vehicle to oversteer or understeer, it is possible to particularly reliably identify a tendency of the vehicle to skid by evaluating the slip angle variable.

The latter is particularly true when the slip angle variable describes a slip angle difference between the slip angle which occurs on the front-wheel axle of the vehicle and the slip angle which occurs on the rear-wheel axle of the vehicle, since it is possible to directly draw conclusions about the occurrence of a tendency of the vehicle to oversteer or understeer, and therefore to skid, on the basis of the magnitude and the mathematical sign of the slip angle difference.

In order to be able to reliably counteract a tendency of the vehicle to tilt and/or skid, it is possible for the evaluation unit to determine a setpoint value, which can be set on the vehicle in order to increase the driving stability, of a yaw moment variable, which describes a yaw moment which acts on the vehicle, in order to carry out vehicle-stabilizing measures as a function of the comparison of the actual value and the setpoint value of the lateral dynamics variable. The vehicle assemblies are then actuated in such a way that an actual value of the yaw moment variable which corresponds to the determined setpoint value is set on the vehicle.

The vehicle assemblies particularly comprise wheel-braking devices which are provided for braking vehicle wheels, with the wheel-braking devices being actuated in order to increase the driving stability of the vehicle by prescribing braking torques and/or braking forces to be generated on selected wheels. Since braking torques and/or braking forces of this type can be generated with a high degree of accuracy and a small time delay specifically in the case of pressure-operated wheel-braking devices, it is possible to carry out the vehicle-stabilizing measures particularly precisely and with a high reaction speed.

The vehicle-stabilizing measures can be carried out in a particularly precise manner if, when prescribing the braking torques and/or braking forces to be generated on selected wheels, a braking torque request and/or braking force request which may be being made by the driver is also taken into account. The braking torque request and/or braking force request may be derived, for example, from operation by the driver of a brake operator control element which is provided for actuating the wheel-braking devices.

In addition to the described actions taken in the wheel-braking devices of the vehicle, vehicle-stabilizing actions may also be taken in the drive and/or in the steering system of the vehicle, for example by suitably-reducing the drive torque and/or in the form of steering corrections which counteract the existing tendency of the vehicle to tilt and/or skid.

The actual value and/or the setpoint value and/or the limit value of the lateral dynamics variable are/is advantageously determined on the basis of an input variable which describes the current movement state of the vehicle. In this case, the actual value and/or the setpoint value and/or the limit value of the lateral dynamics variable can be determined under real-time conditions, so that the device can react immediately to the occurrence of a tendency of the vehicle to tilt and/or skid and the time delays when carrying out the vehicle-stabilizing measures can be largely avoided. If no excessively high requirements are made on the accuracy with which the setpoint value is limited, it is possible to save on the computational outlay which is otherwise required to determine the limit value by definitively prescribing said limit value.

In order to describe the current movement states of the vehicle as accurately as possible, the movement state variable is a longitudinal speed variable which describes a longitudinal speed of the vehicle, and/or is a lateral speed variable which describes a lateral speed of the vehicle, and/or is a lateral acceleration variable which describes a lateral acceleration which acts on the vehicle, and/or is an attitude angle variable which describes the attitude angle of the vehicle, and/or is a yaw rate variable which describes the yaw rate of the vehicle, and/or is a wheel steering angle variable which describes a wheel steering angle which is set on steerable vehicle wheels, and/or is a spring travel variable which describes compression travel which occurs on wheel spring devices of the vehicle, and/or is a roll rate variable which describes the roll rate of the vehicle, and/or is a variable for the center of gravity position, which variable describes the position of the center of gravity of the vehicle, and/or is a static friction variable which describes the static friction occurring between vehicle wheels and the surface of the carriageway.

The device according to the invention and the method according to the invention are explained in greater detail below with reference to the attached drawings, in which:

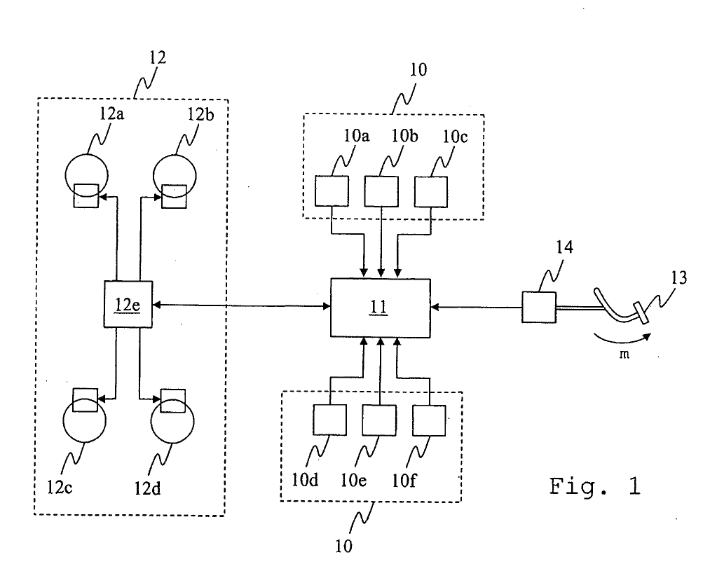

FIG. 1 shows a schematically illustrated exemplary embodiment of the device according to the invention, and

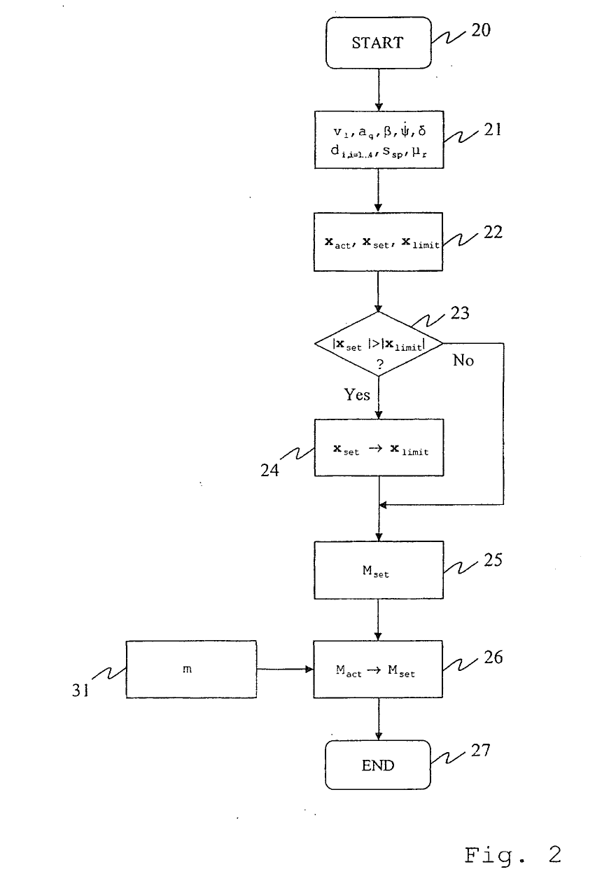

FIG. 2 shows an exemplary embodiment of the method according to the invention in the form of a flow chart.

FIG. 1 shows a schematically illustrated exemplary embodiment of the device for stabilizing a vehicle.

In addition to a detection device 10 which is provided for determining an actual value x_{act} of a lateral dynamics variable which describes the lateral dynamics of the vehicle, the device, which is a stability controller which is based on a Riccati controller and serves to carry out vehicle-stabilizing measures, also has an evaluation unit 11 which is connected to the detection device 10 and determines a setpoint value xₛₑₜ for the lateral dynamics variable, and actuates vehicle assemblies 12, which are provided for influencing the longitudinal and/or lateral dynamics of the vehicle, as a function of a subsequent comparison of the determined actual value x_{act} and the determined setpoint value xₛₑₜ of the lateral dynamics variable in such a way that the driving stability of the vehicle is increased.

The lateral dynamics variable comprises a tilting angle variable φ which describes a tilting angle φ of the vehicle, and/or a slip angle variable α which describes a slip angle α which occurs on a vehicle wheel. In this case, the slip angle α specifies the angle deviation which occurs between the actual rolling direction of the vehicle wheel and the plane of the rim of said vehicle wheel on account of lateral forces of the wheel. In the present exemplary embodiment, the slip angle variable α describes the slip angle αₕ which occurs on a rear-wheel axle of the vehicle, that is to say
α=(αₕ). (1.1)

Furthermore, a relationship of the form

$$φ = ( \begin{matrix}φ \\ \dot{φ} \\ \ddot{φ}\end{matrix} ) \qquad ( 1.2 )$$

should hold true for the tilting angle variable φ which, in the text that follows, describes both the tilting angle φ itself and also the behavior of said tilting angle over time. The actual value x_{act} of the lateral dynamics variable overall is therefore

$${x}_{act} = ( \begin{matrix}φ \\ α\end{matrix} ) = ( \begin{matrix}φ \\ \dot{φ} \\ \ddot{φ} \\ {α}_{h}\end{matrix} ) . \qquad ( 1.3 )$$

The tilting angle φ expresses, for example, a rotation of the vehicle about an axis of rotation which is oriented in the longitudinal direction of the vehicle, that is to say about the roll axis of the vehicle, it alternatively also being possible for the tilting angle to be a rotation about an axis of rotation which is oriented in the lateral direction of the vehicle or a combination of the two rotations described above. The tilting angle variable φ is determined on the basis of spring travel variables d_{i,i=1 . . . 4} which describe compression travel which occurs on wheel spring devices of the vehicle. The tilting angle variable φ is then given on the basis of simple geometric considerations in which, inter alia, the wheel base of the vehicle and the physical distance between the tilting center of the vehicle and the surface of the carriageway are taken into account.

In order to detect the spring travel variables (d_{i,i=1 . . . 4}), spring travel sensors 10a are provided which register the compression travel which occurs at the wheel spring devices and generate corresponding spring travel signals which are supplied to the evaluation unit 11 in order to determine the tilting angle variable φ. In this case, said tilting angle variable can be determined using a suitable observer concept into which, in addition to the spring travel variables (d_{i,i=1 . . . 4}), further input variables which describe the driving dynamics behavior of the vehicle can also be entered, so that said tilting angle variable is determined with a particularly high degree of accuracy.

For reasons of simplicity, the spring travel sensors 10a can be replaced by a tilting angle sensor by means of which the tilting angle φ of the vehicle and/or the behavior of said tilting angle over time can be directly detected in order to determine the tilting angle variable φ. The behavior of the tilting angle φ over time is then given by differentiating the tilting angle φ with respect to time. Since the tilting angle variable φ expresses, for example, a rotation of the vehicle about the roll axis which is oriented in the longitudinal direction of the vehicle, it is particularly possible for the tilting angle sensor to detect a roll rate variable which describes the roll rate of the vehicle, it being possible to obtain the tilting angle φ about the axis of rotation which is oriented in the longitudinal direction of the vehicle by offset-corrected integration of the roll rate variable.

Furthermore, the evaluation unit 11 determines the slip angle variable α on the basis of a longitudinal speed variable vₗ which describes the longitudinal speed of the vehicle, and/or an attitude angle variable β which describes the attitude angle of the vehicle, and/or a yaw rate variable \dot{ψ} which describes the yaw rate of the vehicle, and/or a wheel steering angle variable δ which describes the wheel steering angle which is set on steerable vehicle wheels, with a relationship of the form

$${α}_{h} = β - \frac{\dot{ψ} \cdot {1}_{h}}{{v}_{1}} , \qquad ( 1.4 )$$

forming the basis. In this case, the variable lₕ represents the distance between the center of gravity of the vehicle and the rear-wheel axle of the vehicle in the longitudinal direction of the vehicle.

The longitudinal speed variable vₗ is determined in the evaluation unit 11 by evaluating wheel rotational speed signals which are provided by wheel rotational speed sensors 10b which detect the wheel rotational speeds which occur at vehicle wheels. In parallel with this, the evaluation unit 11 determines the yaw rate variable \dot{ψ} on the basis of a yaw rate signal which is made available by a yaw rate sensor 10c which is provided in order to detect the yaw rate of the vehicle, and the wheel steering angle variable δ on the basis of a wheel steering angle signal which is made available by a wheel steering angle sensor 10d which is provided in order to detect the wheel steering angle.

The attitude angle variable β is then given by the determined longitudinal speed variable vₗ and a determined lateral speed variable v_{q}, which describes a lateral speed of the vehicle, in the relationship

$$β = tg ( \frac{{v}_{g}}{{v}_{1}} ) , \qquad ( 1.5 a )$$

with the lateral speed variable v_{q} being determined by offset-corrected integration of a lateral acceleration variable a_{q} which describes a lateral acceleration which acts on the vehicle. In this case, the lateral acceleration variable a_{q} is determined by the evaluation unit 11 on the basis of a lateral acceleration signal which is provided by a lateral acceleration sensor 10e which detects the lateral acceleration which acts on the vehicle. As an alternative, the lateral speed variable v_{q} may also be measured directly or else determined using an observer model into which, for example, the wheel steering angle variable δ and the longitudinal speed variable vₗ are entered.

The attitude angle variable β generally has low values, so that equation (1.5a) becomes

$$β \approx \frac{{v}_{q}}{{v}_{1}} . \qquad ( 1.5 b )$$

to good approximation.

If it is assumed that the slip between the vehicle tires and the surface of the carriageway can be substantially ignored, the attitude angle variable β can be expressed simply by the determined wheel steering angle variable δ (so-called Ackermann relationship)

$$β \approx δ \cdot \frac{{1}_{h}}{1} , \qquad ( 1.5 c )$$

where the variable l represents the distance between the front-wheel axle and the rear-wheel axle of the vehicle in the longitudinal direction of the vehicle.

The time derivative of the actual value x_{act} of the lateral dynamics variable is examined below in order to realize the stability controller, so that equation (1.3) becomes

$${\dot{x}}_{act} = ( \begin{matrix}\dot{φ} \\ \ddot{φ} \\ {φ}^{…} \\ \dot{{α}_{h}}\end{matrix} ) \qquad ( 1.6 )$$

The vector components which occur in equation (1.6) are determined on the basis of an actual value z_{act} of a state variable which fully and unambiguously characterizes the current movement state of the vehicle. The actual value z_{act} of the state variable is given by the attitude angle β and/or the yaw rate variable \dot{ψ} and/or the tilting angle variable φ. For the time derivative of the actual value z_{act} of the state variable

$${\dot{z}}_{act} = ( \begin{matrix}\dot{β} \\ \ddot{ψ} \\ \dot{φ} \\ \ddot{φ}\end{matrix} ) , \qquad ( 1.7 )$$

it then follows that

$${\dot{z}}_{act} = ( \begin{matrix}{f}_{1} ( β , \dot{ψ} , φ , \dot{φ} , δ ) \\ {f}_{2} ( β , \dot{ψ} , φ , \dot{φ} , δ , {M}_{B , \ddot{ψ}} ) \\ \dot{φ} \\ {f}_{4} ( β , \dot{ψ} , φ , \dot{φ} , δ )\end{matrix} ) , \qquad ( 1.8 )$$

where the variables f₁, f₂ and f₄ represent functional relationships which are provided in order to determine the actual value z_{act} of the state variable and into which, for example, the attitude angle variable β and/or the yaw rate variable \dot{ψ} and/or the tilting angle variable φ and/or the wheel steering angle variable δ and/or a yaw moment variable M_{β\dot{ψ}}, which can be set on the vehicle in order to increase the driving stability and describes a yaw moment which acts on the vehicle, are/is entered.

The actual value x_{act} of the lateral dynamics variable is then given by the actual value z_{act} of the state variable by performing a state transformation of the form
x_{act}=Φ(z_{act}), (1.9)
so that equation (1.6) becomes

$$\begin{matrix}{\dot{x}}_{act} = ( \begin{matrix}\dot{φ} \\ {f}_{3} ( β , \dot{ψ} , φ , \dot{φ} , δ ) \\ {f}_{3} ( β , \dot{ψ} , φ , \dot{φ} , δ , \dot{δ} , {M}_{B , \ddot{ψ}} ) \\ {f}_{4} ( β , \dot{ψ} , φ , \dot{φ} , δ , \dot{δ} , {M}_{B , \ddot{ψ}} )\end{matrix} ) \\ or & ( 1.10 ) \\ {\dot{x}}_{act} = ( \begin{matrix}\dot{φ} \\ \ddot{φ} \\ {f}_{3} ( φ , \dot{φ} , \ddot{φ} , δ , \dot{δ} , {M}_{B , \ddot{ψ}} ) \\ {f}_{4} ( φ , \dot{φ} . \ddot{φ} , δ , \dot{δ} , {M}_{B , \ddot{ψ}} )\end{matrix} ) & ( 1.11 )\end{matrix}$$

The form of the actual value x_{act} of the lateral dynamics variable specified by equation (1.11) considerably simplifies realization of the stability controller. This is primarily the case when equation (1.11) is converted into an input-affine representation of the form

$${\dot{x}}_{act} = ( \begin{matrix}\dot{φ} \\ \ddot{φ} \\ {f}_{3} ( φ , \dot{φ} , \ddot{φ} , δ , \dot{δ} ) + {g}_{3} ( φ , \dot{φ} , \ddot{φ} , δ , \dot{δ} ) {M}_{B , \ddot{ψ}} \\ {f}_{4} ( φ , \dot{φ} , \ddot{φ} , δ , \dot{δ} ) + {g}_{4} ( φ , \dot{φ} , \ddot{φ} , δ , \dot{δ} ) {M}_{B , \ddot{ϕ}}\end{matrix} ) \qquad ( 1.12 )$$

in which the yaw moment variables M_{β\dot{ψ}} which are to be set on the vehicle in order to carry out the vehicle-stabilizing measures are given as coefficients of the functional relationships g₃ and g₄ which are easy to determine.

In the present exemplary embodiment, equation (1.12) gives a total of two setpoint values (Mₛₑₜ)=M_{β\dot{ψ}}, which can be set on the vehicle, for the yaw moment variable

$$\begin{matrix}{M}_{set}^{ϕ} = \frac{\begin{matrix}- {f}_{3} ( φ , \dot{φ} , \ddot{φ} , δ , \dot{δ} ) + \frac{\partial }{\partial t} {\ddot{φ}}_{s} + \\ {q}_{2 , φ} ( {\ddot{φ}}_{s} - \ddot{φ} ) + {q}_{1 , φ} ( {\dot{φ}}_{s} - \dot{φ} ) + {q}_{0 , φ} ( {φ}_{s} - φ )\end{matrix}}{{g}_{3} ( φ , \dot{φ} , \ddot{φ} , δ , \dot{δ} )} , & ( 1.13 a ) \\ {M}_{set}^{α} = \frac{- {f}_{4} ( φ , \dot{φ} , \ddot{φ} , δ , \dot{δ} ) + \frac{\partial }{\partial t} {α}_{h , s} + {q}_{0 , α} ( {α}_{h , s} - {α}_{h} )}{{g}_{3} ( φ , \dot{φ} , \ddot{φ} , δ , \dot{δ} )} . & ( 1.13 b )\end{matrix}$$

The coefficients of the characteristic equations (1.13a) and (1.13b) q_{0,φ}, q_{1,φ}, q_{2,φ} and q_{0,α} represent control amplification factors which allow the control behavior of the stability controller to be prescribed as desired. In this case, in addition to the control characteristics of the vehicle assemblies 12 used to carry out the vehicle-stabilizing measures, the driving dynamics properties of the respective vehicle or type of vehicle (passenger car, heavy-goods vehicle, bus etc.) are to be taken into account too.

The setpoint value xₛₑₜ of the lateral dynamics variable

$${x}_{set} = ( \begin{matrix}{φ}_{s} \\ {\dot{φ}}_{5} \\ {\ddot{φ}}_{s} \\ {α}_{h , s}\end{matrix} ) , \qquad ( 1.14 )$$

which is entered into equations (1.13a) and (1.13b) is determined by the evaluation unit 11 on the basis of the longitudinal speed variable vₗ and/or the attitude angle variable β and/or the yaw rate variable \dot{ψ} and/or the wheel steering angle variable δ and/or the lateral acceleration variable a_{q} and/or a variable sₛₚ for the center of gravity position, which variable describes the position of the center of gravity of the vehicle. The setpoint value xₛₑₜ of the lateral dynamics variable is therefore determined using a functional relationship of the form
xₛₑₜ≡xₛₑₜ(vₗ, a_{q}, β, \dot{ψ}, δ, sₛₚ), (1.15)
which expresses the desired driving dynamics behavior of the respective vehicle or type of vehicle.

In this case, the variable sₛₚ for the center of gravity position is given by evaluating the behavior over time of the compression travel which occurs on the wheel spring devices, that is to say by evaluating the spring travel variables d_{i,i=1 . . . 4} over time.

In order to prevent the vehicle from turning over or skidding, the evaluation unit 11 limits the setpoint value xₛₑₜ of the lateral dynamics variable which is entered into equations (1.13a) and (1.13b) to a limit value xₗᵢₘᵢₜ which is prescribed as a function of a prescribable stability condition if it is found that the magnitude of the setpoint value xₛₑₜ of the lateral dynamics variable exceeds the magnitude of the limit value xₗᵢₘᵢₜ. The limit value xₗᵢₘᵢₜ of the lateral dynamics variable is determined on the basis of the longitudinal speed variable vₗ and/or the lateral acceleration variable a_{q} and/or the wheel steering angle variable δ and/or the variable sₛₚ for the center of gravity position and/or a static friction variable μᵣ which describes the static friction which occurs between vehicle wheels and the surface of the carriageway. The static friction variable μᵣ is determined in the evaluation unit 11 on the basis of a carriageway state signal which is provided by a carriageway state sensor 10f which is provided in order to detect the state of the surface of the carriageway. As an alternative, the limit value xₗᵢₘᵢₜ of the lateral dynamics variable may also be definitively prescribed.

Like the spring travel sensors 10a, the wheel rotational speed sensors 10b, the yaw rate sensor 10c, the wheel steering angle sensor 10d and the lateral acceleration sensor 10e, the carriageway state sensor 10f is a constituent part of the detection device 10.

In this case, the variables which are determined by the evaluation unit 11 by means of the detection device 10 form the input variables for the stability controller. Since these variables describe the current movement state of the vehicle, the setpoint value Mₛₑₜ of the yaw moment variable can be determined under real-time conditions, so that it is possible to react immediately to the occurrence of a tendency of the vehicle to tilt or skid. In order to carry out the vehicle-stabilizing measures, the stability controller in each case uses the setpoint value M^{φ}ₛₑₜ, M^{α}ₛₑₜ specified by equations (1.13a) and (1.13b) which has the greater magnitude,
Mₛₑₜ=Max[|Mₛₑₜ^{φ}|, |Mₛₑₜ^{α}|], (1.16)
it also being feasible as an alternative to correspondingly weight the setpoint values M^{φ}ₛₑₜ, M^{α}ₛₑₜ by means of suitable weighting factors λ_{φ}, λ_{α}
Mₛₑₜ=λ_{φ}Mₛₑₜ^{φ}+λ_{α}Mₛₑₜ^{α}. (1.17)

This procedure has the advantage that the occurrence of both a tendency of the vehicle to tilt and also a tendency of the vehicle to skid can be simultaneously counteracted.

The evaluation unit 11 then actuates the vehicle assemblies 12 as a function of the comparison carried out in equations (1.13a) and (1.13b) between the determined actual value x_{act} and the determined and possibly limited setpoint value xₛₑₜ of the lateral dynamics variable, q_{0,φ}(φₛ−φ), q_{1,φ}(\dot{φ}ₛ−\dot{φ}), q_{:,φ}(\ddot{φ}ₛ−\ddot{φ}) and q_{0,α}(α_{h,s}−αₕ), in such a way that an actual value M_{act} of the yaw moment variable which corresponds to the determined setpoint value Mₛₑₜ is set on the vehicle. In this way, both a tendency of the vehicle to tilt, which leads to it rolling or turning over sideways, and also a tendency of the vehicle to skid, which leads to it lurching or skidding, can be prevented or at least largely suppressed.

The vehicle assemblies 12 are, for example, wheel-braking devices 12a . . . 12d which are provided for braking vehicle wheels and can be actuated by the evaluation unit 11 via a control device 12e. In the case of pressure-operated wheel-braking devices 12a . . . 12d, the control device 12e is an arrangement of electromechanical pressure valves. The wheel-braking device 12a . . . 12d is actuated in accordance with the determined setpoint value Mₛₑₜ of the yaw moment variable by prescribing braking torques and/or braking forces to be generated on selected wheels.

In order to avoid inaccuracies when carrying out the vehicle-stabilizing measures, the evaluation unit 11 takes into account a braking torque request and/or braking force request which may be being made by the driver when prespecifying the braking torques and/or braking forces to be generated on selected wheels. The braking torque request and/or braking force request are produced by operation by the driver of a brake operator control element 13 which is provided for actuating the wheel-braking devices 12a to 12d and is, for example, a conventional brake pedal.

In order to detect operation of the brake operator control element 13 by the driver, a brake operator control element sensor 14 is provided which registers a deflection m which is created by the driver on the brake operator control element 13 and converts said deflection into a corresponding deflection signal which is then supplied to the evaluation unit 11 in order to determine the braking torque request and/or braking force request being made by the driver.

Alternative embodiments of the stability controller will be presented in the text which follows.

According to an alternative embodiment of the device according to the invention, the slip angle variable α describes both the slip angle αₕ which occurs on the rear-wheel axle of the vehicle and also the slip angle αᵥ which occurs on a front-wheel axle of the vehicle, that is to say

$$α = ( \begin{matrix}{α}_{v} \\ {α}_{h}\end{matrix} ) . \qquad ( 2.1 )$$

In this case, a relationship of the form

$$φ = ( \begin{matrix}φ \\ \dot{φ}\end{matrix} ) \qquad ( 2.2 )$$

should hold true for the tilting angle variable φ. The actual value x_{act} of the lateral dynamics variable overall is therefore

$${x}_{act} = ( \begin{matrix}φ \\ α\end{matrix} ) = ( \begin{matrix}φ \\ \dot{φ} \\ {α}_{v} \\ {α}_{h}\end{matrix} ) \qquad ( 2.3 )$$

The evaluation unit 11 determines the slip angle variable α on the basis of the longitudinal speed variable vₗ and/or the attitude angle variable β and/or the yaw rate variable \dot{ψ} and/or the wheel steering angle variable δ, with relationships of the form

$$\begin{matrix}{α}_{v} = - δ + β + \frac{\dot{ψ} \cdot {1}_{v}}{{v}_{1}} \\ and & ( 2.4 ) \\ {α}_{h} = β - \frac{\dot{ψ} \cdot {1}_{h}}{{v}_{1}} & ( 2.5 )\end{matrix}$$

forming the basis. In this case, the variables lᵥ and lₕ represent the distance between the center of gravity of the vehicle and the front-wheel axle and, respectively, the rear-wheel axle of the vehicle in the longitudinal direction of the vehicle.

Following execution of the state transformation
x_{act}=Φ(z_{act}), (2.7)
described in conjunction with the preceding embodiment, an input-affine representation of the form

$${\dot{x}}_{act} = ( \begin{matrix}\dot{φ} \\ {f}_{2} ( φ , \dot{φ} , {α}_{v} , {α}_{h} , δ , \dot{δ} ) \\ {f}_{3} ( φ , \dot{φ} , {α}_{v} , {α}_{h} , δ , \dot{δ} ) + {g}_{3} ( φ , \dot{φ} , {α}_{v} , {α}_{h} , δ , \dot{δ} ) {M}_{B , \ddot{ψ}} \\ {f}_{4} ( φ , \dot{φ} , {α}_{v} , {α}_{h} , δ , \dot{δ} ) + {g}_{4} ( φ , \dot{φ} , {α}_{v} , {α}_{h} , δ , \dot{δ} ) {M}_{B , \ddot{ψ}}\end{matrix} ) . \qquad ( 2.8 )$$

which is analogous to equation (1.12) is given.

As can be seen, equation (2.8) then provides only one single setpoint value Mₛₑₜ=M_{β\dot{ψ}} for the yaw moment variable which is to be set on the vehicle, so that prioritization or weighting in accordance with equation (1.16) or (1.17), as is always required when there are a plurality of setpoint values Mₛₑₜ, can be dispensed with. In this way, reliability when carrying out the vehicle-stabilizing measures can be further improved.

According to a further alternative embodiment of the device according to the invention, the slip angle variable α describes the slip angle difference Δα=aᵥ−aₕ between the slip angle aᵥ which occurs on the front-wheel axle of the vehicle and the slip angle aₕ which occurs on the rear-wheel axle of the vehicle, that is to say
α=(Δα) (3.1)

In this case, a relationship of the form

$$φ = ( \begin{matrix}φ \\ \dot{φ} \\ \ddot{φ}\end{matrix} ) \qquad ( 3.2 )$$

should hold true for the tilting angle variable φ. The actual value x_{act} of the lateral dynamics variable is therefore

$${x}_{act} = ( \begin{matrix}φ \\ α\end{matrix} ) = ( \begin{matrix}φ \\ \dot{φ} \\ \ddot{φ} \\ Δ α\end{matrix} ) , \qquad ( 3.3 )$$

with an input-affine representation of the form
x_{act}=Φ(z_{act}) (3.4)
now being produced following execution of the state transformation

$${\dot{x}}_{act} = ( \begin{matrix}\dot{φ} \\ \ddot{φ} \\ {f}_{3} ( φ , \dot{φ} , \ddot{φ} , Δ α , δ , \dot{δ} ) + {g}_{3} ( φ , \dot{φ} , \ddot{φ} , Δ α , δ , \dot{δ} ) {M}_{B , \ddot{ψ}} \\ {f}_{4} ( φ , \dot{φ} , \ddot{φ} , Δ α , δ , \dot{δ} ) + {g}_{4} ( φ , \dot{φ} , \ddot{φ} , Δ α , δ , \dot{δ} ) {M}_{B , \ddot{ψ}}\end{matrix} ) \qquad ( 3.5 )$$

Like equation (2.6), equation (3.5) provides only one single setpoint value Mₛₑₜ=M_{β\dot{ψ}} for the yaw moment variable which is to be set on the vehicle, it being ensured that the vehicle-stabilizing measures are carried out in a particularly reliable manner on account of the slip angle difference Δα=αᵥ−αₕ being taken into account.

FIG. 2 shows an exemplary embodiment of the method according to the invention in the form of a flowchart.

The method is started in an initialization step 20, after which the longitudinal speed variable vₗ and/or the lateral speed variable v_{q} and/or the lateral acceleration variable a_{q} and/or the attitude angle variable β and/or the yaw rate variable \dot{ψ} and/or the wheel steering angle variable δ and/or the spring travel variables d_{i,i=1 . . . 4} and/or the rolling rate variable and/or the variable sₛₚ for the center of gravity position and/or the static friction variable μᵣ are/is determined in a first main step 21. These variables form the input variables for the stability controller.

In a second main step 22, the actual value x_{act}, the setpoint value xₛₑₜ and the limit value xₗᵢₘᵢₜ of the lateral dynamics variable are determined on the basis of the input variables determined in the preceding first main step 21.

If it is established in a third main step 23 that the magnitude of the determined setpoint value xₛₑₜ of the lateral dynamics variable exceeds the magnitude of the determined limit value xₗᵢₘᵢₜ
|xₛₑₜ|>xₗᵢₘᵢₜ|, (4.1)
the determined setpoint value xₛₑₜ of the lateral dynamics variable is limited to the determined limit value xₗᵢₘᵢₜ in a fourth main step 24. The method is then continued with a fifth main step 25.

If, in contrast, it is identified in the third main step 23 that the condition specified by equation (4.1) is not satisfied, the method continues directly with the fifth main step 25.

In the fifth main step 25, the setpoint value Mₛₑₜ of the yaw moment variable which is set on the vehicle in order to increase the driving stability is determined as a function of the comparison of the determined actual value x_{act} and the determined setpoint value xₛₑₜ, which may have been limited in the fourth main step 24, of the lateral dynamics variable, after which the longitudinal and/or lateral dynamics of the vehicle are influenced in a sixth main step 26 in such a way that an actual value M_{act} of the yaw moment variable which corresponds to the determined setpoint value Mₛₑₜ is set on the vehicle. A braking torque request and/or braking force request being made by the driver is taken into account here. Said braking torque request and/or braking force request are/is given by the deflection m which is created by the driver on the brake operator control element 13 and is provided in a first substep 31.

The method is then ended in a final step 27.

1. A device for stabilizing a vehicle, having a detection device (10) which is provided for determining an actual value (x_{act}) of a lateral dynamics variable which describes the lateral dynamics of the vehicle, and having an evaluation unit (11) which determines a setpoint value (xₛₑₜ) for the lateral dynamics variable and limits said setpoint value to a limit value (xₗᵢₘᵢₜ) which is determined as a function of a prescribed stability condition if it is found that the magnitude of the setpoint value (xₛₑₜ) of the lateral dynamics variable exceeds the magnitude of the determined limit value (xₗᵢₘᵢₜ), with the evaluation unit (11) actuating vehicle assemblies (12), which are provided for influencing the longitudinal and/or lateral dynamics of the vehicle, as a function of a comparison of the determined actual value (x_{act}) and the determined and possibly limited setpoint value (xₛₑₜ) of the lateral dynamics variable in such a way that the driving stability of the vehicle is increased, characterized in that the lateral dynamics variable comprises a tilting angle variable (φ) which describes a tilting angle (φ) of the vehicle, and/or a slip angle variable (α) which describes a slip angle (α) which occurs on a vehicle wheel.

2. The device as claimed in claim 1, characterized in that the tilting angle variable (φ) describes the tilting angle (φ) itself and/or the behavior of the tilting angle (φ) over time.

3. The device as claimed in claim 1, characterized in that the slip angle variable (α) describes the slip angle (αᵥ) which occurs on a front-wheel axle of the vehicle and/or the slip angle (αₕ) which occurs on a rear-wheel axle of the vehicle.

4. The device as claimed in claim 1, characterized in that the slip angle variable (α) describes a slip angle difference (Δα) between the slip angle (αᵥ) which occurs on the front-wheel axle of the vehicle and the slip angle (αₕ) which occurs on the rear-wheel axle of the vehicle.

5. The device as claimed in claim 1, characterized in that the evaluation unit (11) determines a setpoint value (Mₛₑₜ), which can be set on the vehicle in order to increase the driving stability, of a yaw moment variable, which describes a yaw moment which acts on the vehicle, as a function of the comparison of the actual value (x_{act}) and the setpoint value (xₛₑₜ) of the lateral dynamics variable, with the vehicle assemblies (12) then being actuated in such a way that an actual value (M_{act}) of the yaw moment variable which corresponds to the determined setpoint value (Mₛₑₜ) is set on the vehicle.

6. The device as claimed in claim 1, characterized in that the vehicle assemblies (12) comprise at least wheel-braking devices (12a . . . 12d) which are provided for braking respectively associated vehicle wheels, with the wheel-braking devices (12a . . . 12d) being actuated in order to increase the driving stability by prescribing braking torques and/or braking forces to be generated on selected wheels.

7. The device as claimed in claim 6, characterized in that, when prescribing the braking torques and/or braking forces to be generated on selected wheels, the evaluation unit (11) takes into account a braking torque request and/or braking force request which may be being made by the driver.

8. The device as claimed in claim 1, characterized in that the evaluation unit (11) determines the actual value (x_{act}) of the lateral dynamics variable on the basis of an input variable which describes the current movement state of the vehicle.

9. The device as claimed in claim 1, characterized in that the evaluation unit (11) determines the setpoint value (xₛₑₜ) of the lateral dynamics variable on the basis of an input variable which describes the current movement state of the vehicle.

10. The device as claimed in claim 1, characterized in that the limit value (xₗᵢₘᵢₜ) of the lateral dynamics variable is either definitively prescribed or else is determined by the evaluation unit (11) on the basis of an input variable which describes the current movement state of the vehicle.

11. The device as claimed in claim 10, characterized in that the input variable is a longitudinal speed variable (vₗ) which describes a longitudinal speed of the vehicle, and/or is a lateral speed variable which describes a lateral speed (v_{q}) of the vehicle, and/or is a lateral acceleration variable (a_{q}) which describes a lateral acceleration which acts on the vehicle, and/or is an attitude angle variable (β) which describes the attitude angle of the vehicle, and/or is a yaw rate variable (\dot{ψ}) which describes the yaw rate of the vehicle, and/or is a wheel steering angle variable (δ) which describes a wheel steering angle which is set on steerable vehicle wheels, and/or is a spring travel variable (d_{i,i=1 . . . 4}) which describes compression travel which occurs on wheel spring devices of the vehicle, and/or is a roll rate variable which describes the roll rate of the vehicle, and/or is a variable (sₛₚ) for the center of gravity position, which variable describes the position of the center of gravity of the vehicle, and/or is a static friction variable (μᵣ) which describes the static friction occurring between vehicle wheels and the surface of the carriageway.

12. A method for stabilizing a vehicle, in which an actual value (x_{act}) of a lateral dynamics variable which describes the lateral dynamics of the vehicle is determined, and in which a setpoint value (xₛₑₜ) for the lateral dynamics variable is determined and limited to a limit value (xₗᵢₘᵢₜ) which is determined as a function of a prescribed stability condition if it is established that the magnitude of the setpoint value (xₛₑₜ) of the lateral dynamics variable exceeds the magnitude of the determined limit value (xₗᵢₘᵢₜ), with the longitudinal and/or lateral dynamics of the vehicle being influenced as a function of a comparison of the determined actual value (x_{act}) and the determined and possibly limited setpoint value (xₛₑₜ) of the lateral dynamics variable in such a way that the driving stability of the vehicle is increased, characterized in that the lateral dynamics variable comprises a tilting angle variable (φ) which describes a tilting angle (φ) of the vehicle, and/or a slip angle variable (α) which describes a slip angle (α) which occurs on a vehicle wheel.

13. The device as claimed in claim 8, wherein the input variable is a longitudinal speed variable (vₗ) which describes a longitudinal speed of the vehicle, and/or is a lateral speed variable which describes a lateral speed (v_{q}) of the vehicle, and/or is a lateral acceleration variable (a_{q}) which describes a lateral acceleration which acts on the vehicle, and/or is an attitude angle variable (β) which describes the attitude angle of the vehicle, and/or is a yaw rate variable (\dot{ψ}) which describes the yaw rate of the vehicle, and/or is a wheel steering angle variable (δ) which describes a wheel steering angle which is set on steerable vehicle wheels, and/or is a spring travel variable (d_{i,i=1 . . . 4}) which describes compression travel which occurs on wheel spring devices of the vehicle, and/or is a roll rate variable which describes the roll rate of the vehicle, and/or is a variable (sₛₚ) for the center of gravity position, which variable describes the position of the center of gravity of the vehicle, and/or is a static friction variable (μᵣ) which describes the static friction occurring between vehicle wheels and the surface of the carriageway.

14. The device as claimed in claim 9, wherein the input variable is a longitudinal speed variable (vₗ) which describes a longitudinal speed of the vehicle, and/or is a lateral speed variable which describes a lateral speed (v_{q}) of the vehicle, and/or is a lateral acceleration variable (a_{q}) which describes a lateral acceleration which acts on the vehicle, and/or is an attitude angle variable (β) which describes the attitude angle of the vehicle, and/or is a yaw rate variable (\dot{ψ}) which describes the yaw rate of the vehicle, and/or is a wheel steering angle variable (δ) which describes a wheel steering angle which is set on steerable vehicle wheels, and/or is a spring travel variable (d_{i,i=1 . . . 4}) which describes compression travel which occurs on wheel spring devices of the vehicle, and/or is a roll rate variable which describes the roll rate of the vehicle, and/or is a variable (sₛₚ) for the center of gravity position, which variable describes the position of the center of gravity of the vehicle, and/or is a static friction variable (μᵣ) which describes the static friction occurring between vehicle wheels and the surface of the carriageway.
